(19) United States
(12) Patent Application Publication
(10) Pub. No.: US 2008/0140707 A1
(43) Pub. Date: Jun. 12, 2008

(54) System and method for clustering using indexes

(75) Inventors: Kevin John Lang, Mountain View, CA (US); Vijay Murthi, Glendale, CA (US)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 11/637,542

(22) Filed: Dec. 11, 2006

(51) Int. Cl. G06F 7/06; G06F 17/30

(52) U.S. Cl. 707/103 Y; 707/E17.009

(57) ABSTRACT

An improved system and method is provided for clustering objects using indexes for a matrix representing a collection of objects. Objects to be clustered may be represented as a rectangular matrix. An index may be created for accessing the rows of the matrix and an inverted index may be created for accessing the columns of the matrix based upon the connectivity of the edges between rows and columns of the matrix. Each node represented by a row may be joined to a nearest node represented by another row to produce disjoint sets of nodes. The disjoint sets of nodes may represent clusters that may then be output for use by an application. Moreover, the objects to be clustered may be clusters of objects that may be correlated into a hierarchy of clusters of objects.

### FIELD OF THE INVENTION

The invention relates generally to computer systems, and more particularly to an improved system and method for clustering objects using indexes for a matrix representing a collection of objects.

### BACKGROUND OF THE INVENTION

There may be many applications that may use hierarchical clustering to identify related groups of users or objects. The relationship of objects may be represented by a matrix that is often sparse. A classic algorithm, called the “single-link algorithm”, may be typically used for producing hierarchical clustering of objects whose relationship may be represented by a sparse matrix. This classic algorithm may compute the similarities between all pairs of rows and produce a complete list of pairs sorted by similarity. Kruskal's maximum-spanning tree algorithm may then be applied to the list of pairs sorted by similarity to generate clusters by merging nodes.

Although functional, this method may be expensive and may result in an undesirable output tree. For instance, there may be M² pairs of rows, so computing and sorting all of the similarities can be too expensive both in terms of time and space. Second, rather than producing a wider and shallower tree, the output tree generated can be very unbalanced and deep. In order to generate a shallower tree, a modified version of Kruskal's algorithm may be applied that may proceed in about log n rounds. In each round, the modified version of Kruskal's algorithm may merge nodes with nodes and nodes with clusters, but not clusters with clusters. Between rounds, clusters are contracted into new nodes. This still may remain very expensive, because the input to Kruskal's algorithm may be a sorted list of all node pairs.

What is needed is a way to more efficiently perform hierarchical clustering for identifying related groups of users or objects. Such a system and method should work for any type of objects, including objects that may be clusters themselves so that clusters may be correlated into a hierarchy of clusters.

### SUMMARY OF THE INVENTION

Briefly, the present invention may provide a system and method for clustering objects using indexes for a matrix representing a collection of objects. To do so, a clustering analysis engine may be provided that may provide services for grouping objects into clusters of objects. In an embodiment, a clustering analysis engine may include an operably coupled index generator for creating indexes on the rows and columns of a matrix representing the objects to be clustered, a correlation analyzer for identifying objects which may be correlated, and a cluster generator for creating clusters by joining correlated objects in the same cluster. In an embodiment, the objects may be clusters themselves that may be correlated into a hierarchy of clusters. In particular, objects to be clustered may be represented as a rectangular matrix. An index may be created for accessing the rows of the matrix and an inverted index may be created for accessing the columns of the matrix based upon the connectivity of the edges between rows and columns of the matrix. Each node represented by a row may be joined to a nearest node represented by another row to produce disjoint sets of nodes. The nearest node represented by a row may be efficiently found by using the index and inverted index to find rows with nonzero overlap with the row representing the initial node. The disjoint sets of nodes may represent clusters that may then be output for use by an application.

The present invention may support many applications for clustering objects using indexes for a matrix. For example, an application may wish to cluster groups of online users according to membership lists. Or an application for online advertisement auctions may wish to cluster bidded phrases according to bidding patterns. For any of these applications, objects with related attributes or classes of attributes may be represented by a matrix and efficiently clustered using indexes for the matrix. Furthermore, the present invention may also correlate clusters of objects to produce a hierarchy of clusters.

Advantageously, the present invention may use an index and an inverted index to efficiently compute similarities between objects represented by a matrix for clustering. Any types of objects with related attributes or classes of attributes may be represented by a matrix and clustered using indexes for the matrix. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for clustering objects using indexes for a matrix representing the objects, in accordance with an aspect of the present invention;

FIG. 3 is a flowchart generally representing the steps undertaken in one embodiment for clustering objects using indexes for a matrix representing the objects, in accordance with an aspect of the present invention;

FIG. 4 is a flowchart generally representing the steps undertaken in one embodiment for producing disjoint sets of nearest nodes of a matrix accessed using indexes, in accordance with an aspect of the present invention;

FIG. 5 is a flowchart generally representing the steps undertaken in one embodiment for performing hierarchical clustering by correlating clusters at each level of the hierarchy of clusters using indexes for a matrix representing a relationship between clusters, in accordance with an aspect of the present invention; and

FIG. 6 is a flowchart generally representing the steps undertaken in another embodiment for performing hierarchical clustering by correlating clusters at each level of the hierarchy of clusters using indexes for a matrix representing a relationship between clusters, in accordance with an aspect of the present invention.

### DETAILED DESCRIPTION

### Exemplary Operating Environment

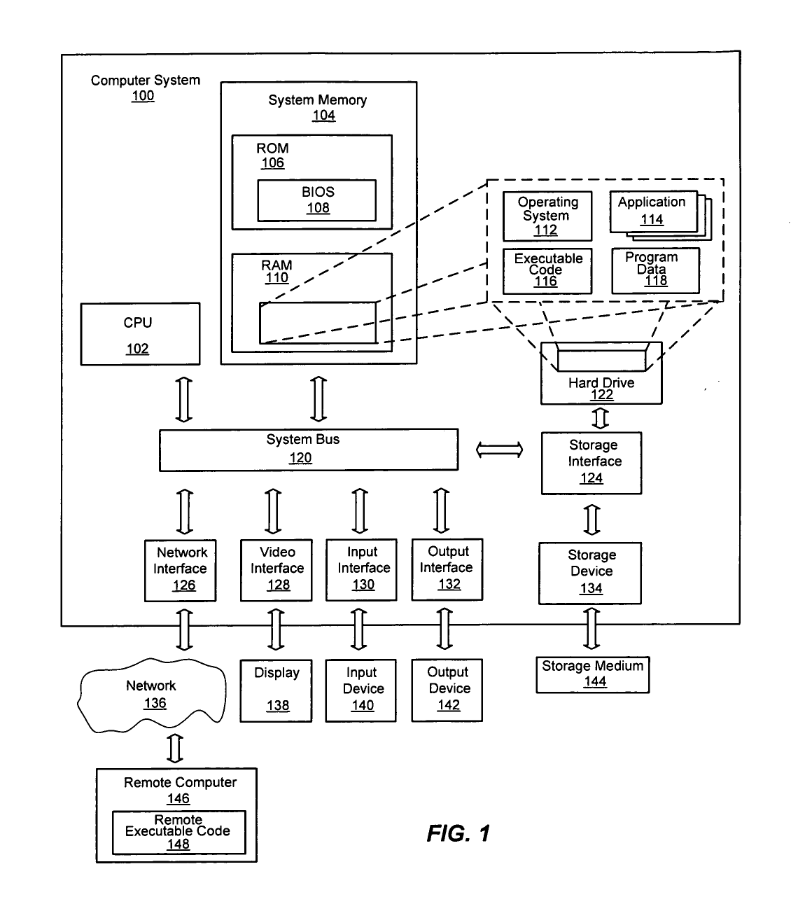

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Clustering Using Indexes for a Matrix

The present invention is generally directed towards a system and method for clustering objects using indexes for a matrix representing a collection of objects. More particularly, objects to be clustered may be represented as a rectangular matrix. An index may be created for accessing the rows of the matrix and an index may be created for accessing the columns of the matrix based upon the connectivity of the edges between rows and columns of the matrix. Each node represented by a row may be joined to a nearest node represented by another row to produce disjoint sets of nodes. The disjoint sets of nodes may represent clusters that may then be output for use by an application.

As will be seen, the present invention may support many applications for clustering objects using indexes for a matrix representing the objects to be clustered. For example, an application may wish to cluster groups of online users according to membership lists. Furthermore, the present invention may also correlate clusters of objects to produce a hierarchy of clusters. As will be understood, the various block diagrams, flow charts and scenarios described herein are only examples, and there are many other scenarios to which the present invention will apply.

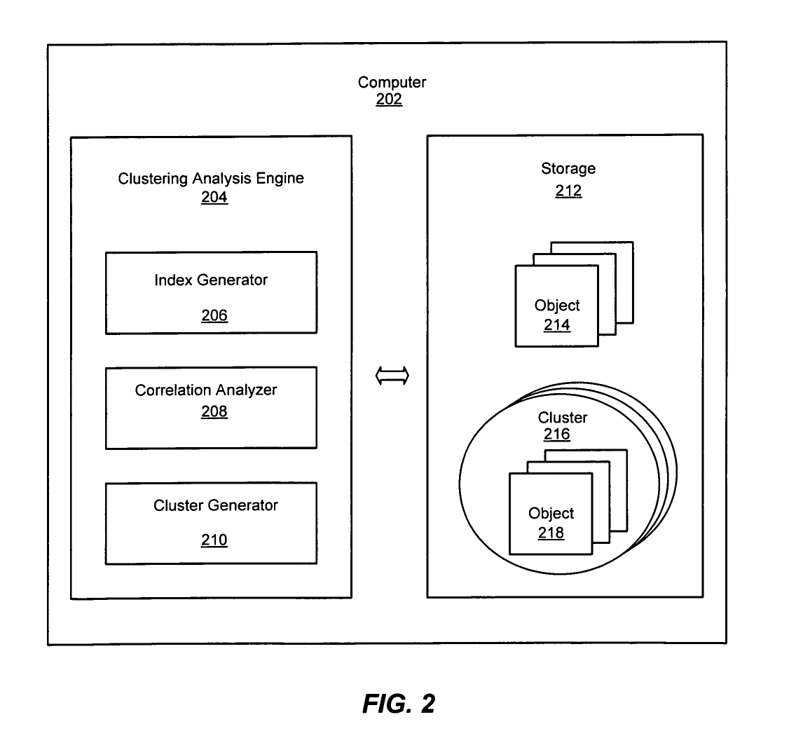

Turning to FIG. 2 of the drawings, there is shown a block diagram generally representing an exemplary architecture of system components for clustering objects using indexes for a matrix representing the objects. Those skilled in the art will appreciate that the functionality implemented within the blocks illustrated in the diagram may be implemented as separate components or the functionality of several or all of the blocks may be implemented within a single component. For example, the functionality for the cluster generator 210 may be included in the same component as the correlation analyzer 208. Or the functionality of the index generator 206 may be implemented as a separate component from the clustering analysis engine 204.

In various embodiments, a computer 202, such as computer system 100 of FIG. 1, may include a clustering analysis engine 204 operably coupled to storage 212. In general, the clustering analysis engine 204 may be any type of executable software code such as a kernel component, an application program, a linked library, an object with methods, and so forth. The storage 212 may be any type of computer-readable media and may store objects 214 and clusters 216 of objects 218.

The clustering analysis engine 204 may provide services for grouping objects 214 into clusters 216 of objects 218. In an embodiment, the objects 214 may be clusters themselves that may be correlated into a hierarchy of clusters. The clustering analysis engine 204 may include an index generator 206 for creating indexes on the rows and columns of a matrix representing the objects to be clustered, a correlation analyzer for identifying objects which may be correlated. Each of these modules may also be any type of executable software code such as a kernel component, an application program, a linked library, an object with methods, or other type of executable software code. The clustering analysis engine 204 may create clusters by joining correlated objects in the same cluster.

There are many applications which may use the present invention for clustering objects using indexes for a matrix. For example, an application may wish to cluster groups of online users according to membership lists. Or an application for online advertisement auctions may wish to cluster bidded phrases according to bidding patterns. For any of these applications, objects with related attributes or classes of attributes may be represented by a matrix and clustered using indexes for the matrix. Furthermore, those skilled in the art will appreciate that the present invention may also correlate clusters of objects to produce a hierarchy of clusters.

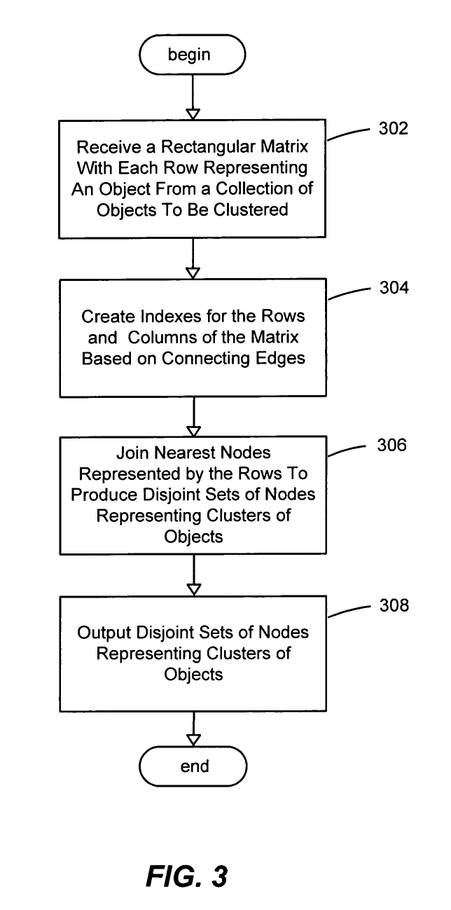

FIG. 3 presents a flowchart generally representing the steps undertaken in one embodiment for clustering objects using indexes for a matrix representing the objects. At step 302, a rectangular matrix with each row representing an object from a collection of objects to be clustered may be received. In an embodiment, each object may be related to an attribute or class of attributes and this relationship may be represented by an m×n matrix, S(m,n), where m=1, . . . , M may represent the objects and n=1, . . . , N may represent the attributes or classes of attributes. For instance, users of an online web portal may be members of one or more services provided by the online web portal. Each user may be represented by a row in the matrix and each service or class of services may be represented by a column in the matrix. A non-zero entry for Sₘₙ may indicate that an object may have a relationship to a class of attributes. This matrix representing the relationship between objects and attributes, or classes of attributes, may be viewed as a bipartite graph with M nodes on the left side and N nodes on the right side and edges from M to N as non-zeros.

Once the relationship between objects and classes of attributes may be represented as an m×n matrix, indexes may be created at step 304 for the M nodes and the N nodes based on the connectivity of the edges between M and N. In an embodiment, a forward index for the M nodes representing rows of the matrix may be created. For example, an array, which may be denoted as R, may be created that includes a list of nonzero columns for each row and another array that stores the offset to the array R for each row. Thus, the forward index may map objects to attributes. A backward index for the N nodes representing the columns of the matrix may also be created. For instance, an array, which may be denoted as O, may be created that includes a list of nonzero rows for each column and another array that stores an offset to the array O for each column. Accordingly, the backward index may map attributes to objects.

Each node in M may then be joined to a nearest node in M to produce disjoint sets of nodes at step 306. These disjoint sets of nodes may represent individual clusters. In an embodiment, a depth-2 depth first search (DFS) may be performed on the nodes of M, first using the forward index and then using the backward index, to find a most correlated connected node in M that may be joined into a disjoint set using a union-find algorithm. An indication of the disjoint sets representing individual clusters of objects may then be output at step 308 and processing may be finished for clustering objects using indexes for a matrix.

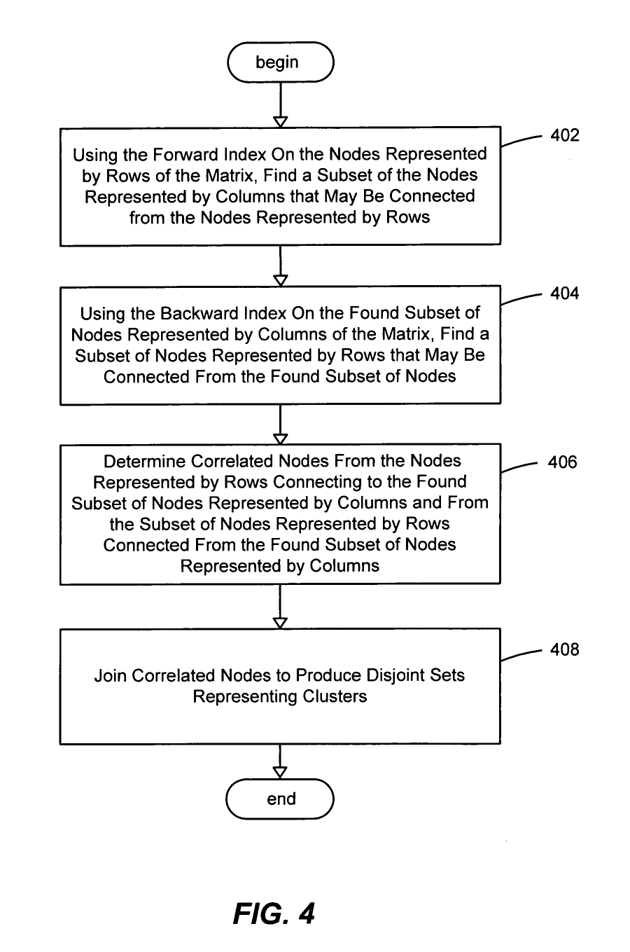

FIG. 4 presents a flowchart generally representing the steps undertaken in one embodiment for producing disjoint sets of nearest nodes of a matrix accessed using the indexes. For each row node, the forward index on M may be used at step 402 to map a row node xₘ to a subset Z of column nodes connected to xₘ by an edge in the bipartite graph representing the matrix.

At step 404, the backward index on N may be used to map each found column node zⱼ in Z to the subset Yⱼ of row nodes connected to zⱼ by an edge in the bipartite graph representing the matrix. Consider C to denote the union of the sets Yⱼ, and for each row node yₖ in C, consider ov(k) to denote the number of times the node yₖ was seen while computing this union.

Note that the nodes yₖ in C may be exactly those nodes that are two steps away from the current node yₘ in the bipartite graph representing the matrix. Therefore, steps 402 and 404 can also be described as performing a depth-2 DFS. The rows corresponding to the nodes yₖ in C may be exactly those rows with nonzero overlap with the row corresponding to yₘ. The counts ov(k) may represent the overlaps, from which several different similarity scores including correlation and cosine similarity may be computed.

At step 406, correlated nodes in M may be determined by using the overlaps ov(k) to compute one of several similarity scores (including correlation and cosine similarity) between the current node xₘ and each node yₖ in C. The row node yₘ in C that may be most correlated with xₘ may then be chosen.

The current node xₘ, which may have a correlation of 1, may be excluded from consideration of the nodes of C when determining a most correlated node yₘ. In other embodiments, weights may be used for nodes or edges or both to determine correlation. In such embodiments, edge weights on indexes may be pre-computed and stored, and node weights on an indexed array may be pre-computed and stored.

At step 408, each node xₘ may be joined with its most correlated node yₘ. In an embodiment, a node xₘ may be joined with a correlated node yₘ if the similarity metric may exceed a defined threshold. In various embodiments, the nodes of M may be stored on a disjoint sets data structure and may be joined using a well-known union-find algorithm. The result of joining nodes xₘ with correlated nodes yₘ may produce disjoint sets of nodes representing individual clusters. When the disjoint sets of nodes may have been produced, processing may be finished for producing disjoint sets of nearest nodes of a matrix accessed using indexes.

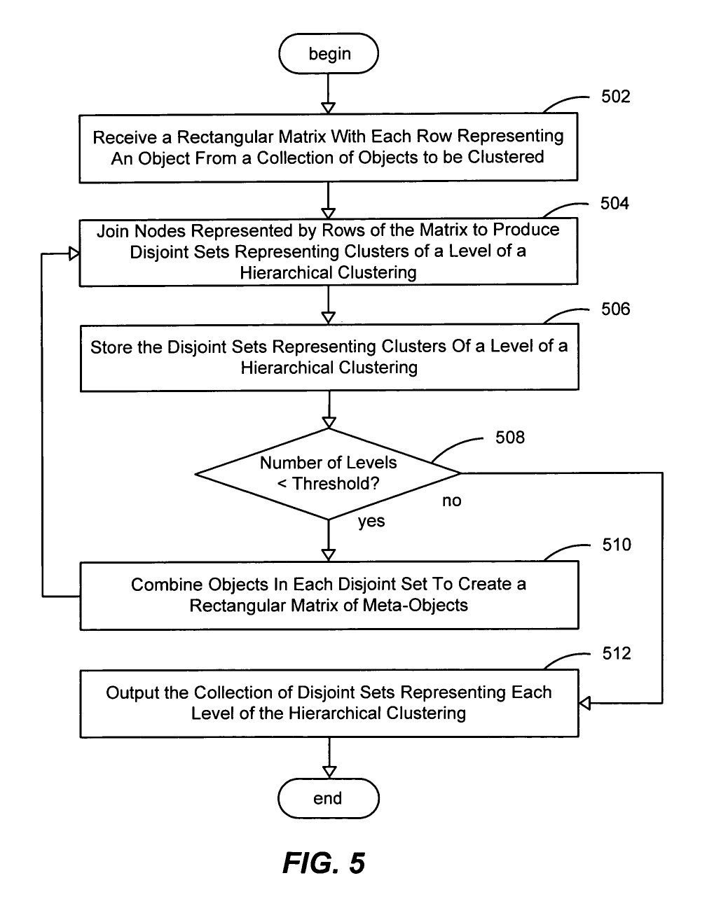

A hierarchical clustering may be produced by iterating the steps generally described in conjunction with FIGS. 3 and 4 to produce clusters at each level of the hierarchical clustering. FIG. 5 presents a flowchart generally representing the steps undertaken in one embodiment for performing hierarchical clustering by correlating clusters at each level of the hierarchy of clusters using indexes for a matrix representing a relationship between clusters. At step 502, a rectangular matrix may be received with each row representing an object from a collection of objects to be clustered. In an embodiment, each object may be related to an attribute or class of attributes as previously described in conjunction with FIG. 3 and this relationship may be represented by an m×n matrix, S(m,n), where m=1, . . . , M may represent the objects and n=1, . . . , N may represent the attributes or classes of attributes. A non-zero entry for Sₘₙ may indicate that an object may have a relationship to a class of attributes. This matrix representing the relationship between objects and attributes, or classes of attributes, may be viewed as a bipartite graph with M nodes on the left side and N nodes on the right side and edges from M to N as non-zeros.

At step 504, the nodes represented by rows of the matrix may be joined to produce disjoint sets representing clusters of a level of the hierarchical clustering. In an embodiment, the steps of FIG. 4 may be executed for producing disjoint sets of nearest nodes of the matrix that may represent correlated clusters of a level of the hierarchical clustering.

At step 506, the disjoint sets representing clusters of a level of the hierarchical clustering may be stored. And it may be determined at step 508 whether the number of levels of the hierarchical clustering may be less than a threshold. If so, then the objects of a disjoint set may be combined for each of the disjoint sets to create a rectangular matrix of meta-objects and processing may continue at step 504. The objects of a disjoint set may be combined in an embodiment by OR'ing or summing the rows of objects belonging to the disjoint set, or by contracting the object nodes of a disjoint set in the bipartite graph view of the relationship of the collection of objects or clusters. Note that the rectangular matrix of meta-objects may represent the relationship between clusters and attributes, or clusters of attributes at a level of the hierarchical clustering. In various embodiments, a weighted version of the clustering algorithm may be used for clustering at levels 2 and above of the hierarchical clustering.

If it may be determined at step 508 that the number of levels of the hierarchical clustering may not be less than a threshold, the collection of disjoint sets representing each level of the hierarchical clustering may be output at step 510, and processing may be finished for performing hierarchical clustering by correlating clusters at each level of the hierarchy of clusters using indexes for a matrix representing a relationship between clusters.

In an alternate embodiment, a hierarchical clustering may be produced by iterating the steps generally described in conjunction with FIGS. 3 and 4, and by using the initial dataset of the collection of object when computing the similarities of all pairs of objects, or clusters, that have nonzero overlap at each level of the hierarchical clustering.

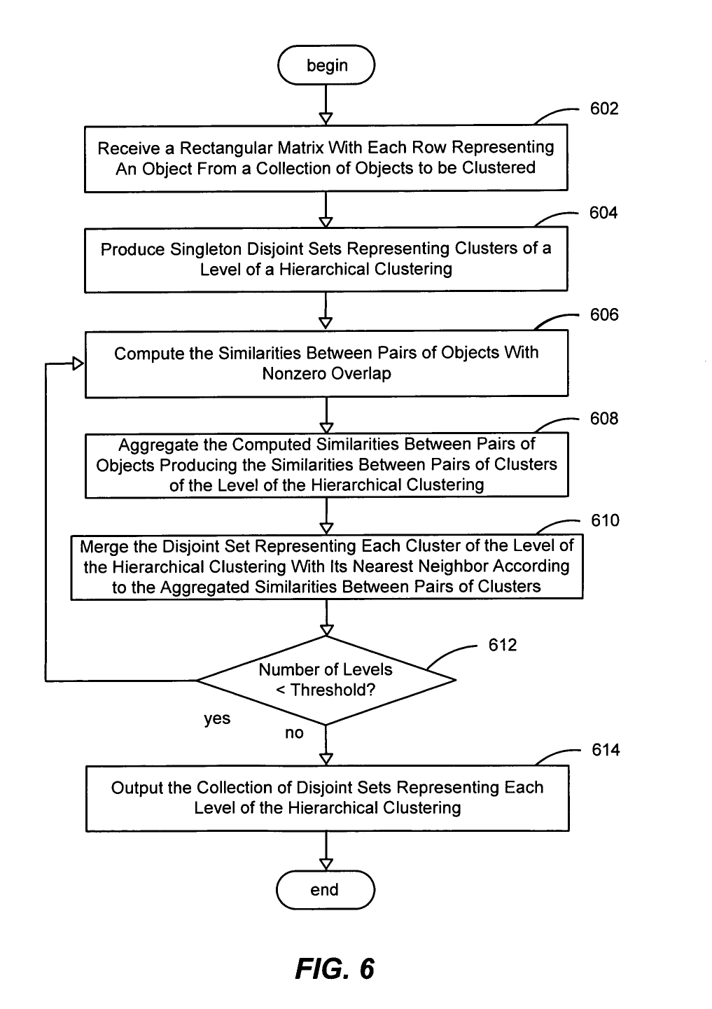

FIG. 6 presents a flowchart generally representing the steps undertaken in another embodiment for performing hierarchical clustering by correlating clusters at each level of the hierarchy of clusters using indexes for a matrix representing a relationship between clusters. At step 602, a rectangular matrix may be received with each row representing an object from a collection of objects to be clustered. In an embodiment, each object may be related to an attribute or class of attributes as previously described in conjunction with FIG. 3 and this relationship may be represented by an m×n matrix, S(m,n), where m=1, . . . , M may represent the objects and n=1, . . . , N may represent the attributes or classes of attributes. A non-zero entry for Sₘₙ may indicate that an object may have a relationship to a class of attributes. This matrix representing the relationship between objects and attributes, or classes of attributes, may be viewed as a bipartite graph with M nodes on the left side and N nodes on the right side and edges from M to N as non-zeros.

At step 604, the nodes represented by rows of the matrix may be used to produce singleton disjoint sets representing singleton clusters of a first level of the hierarchical clustering. At step 606, the similarities between pairs of objects that have nonzero overlap may be computed. In an embodiment, any of the several similarity scores (including correlation and cosine similarity) described in conjunction with step 406 of FIG. 4 may be used to compute the similarities between pairs of objects that have nonzero overlap.

At step 608, the computed similarities between pairs of objects producing the similarities between pairs of clusters of the level of the hierarchical clustering may be aggregated. In an embodiment, the computed similarities between pairs of objects may be combined using aggregation operators, such as minimum, maximum and average, into aggregated similarities between pairs of clusters. At step 610, the disjoint set representing each cluster of the level of the hierarchical clustering may be merged with its nearest neighbor according to the aggregated similarities between pairs of clusters. This may produce in an embodiment a smaller collection of bigger disjoint sets that may be viewed as the next level of the hierarchical clustering.

It may then be determined at step 612 whether the number of levels of the hierarchical clustering may be less than a threshold. If so, then processing may continue at step 606, and the similarities between pairs of objects that have nonzero overlap may be computed If it may be determined at step 612 that the number of levels of the hierarchical clustering may not be less than a threshold, the collection of disjoint sets representing each level of the hierarchical clustering may be output at step 614, and processing may be finished for performing hierarchical clustering by correlating clusters at each level of the hierarchy of clusters using indexes for a matrix representing a relationship between clusters.

Those skilled in the art will appreciate that the present invention may also be used to perform collaborative filtering to identify clusters of attributes for clusters of objects such as identifying a music playlist of a group of people. To do so, the methods of the present invention described by FIGS. 4-6 may be applied to a transpose of a rectangular matrix representing the relationship of objects or clusters of objects to attributes or clusters of attributes.

Thus the present invention may efficiently cluster objects that may be represented by a large matrix that may be sparse. Advantageously, large similarities and near neighbors represented by the edges of the matrix may be computed by performing a depth first search-2. Thus, the cost of computing near neighbors over the rows may be the sum of the squares of the degrees of column nodes, which may be significantly less in practice than the number of rows squared. Moreover, the computation may be flexibly performed in parallel as desired. By joining correlated nodes using a union-find algorithm, the merging of nearest nodes may take nearly linear time. Thus, the cost of computing the nearest neighbors may represent the dominant cost for clustering objects.

As can be seen from the foregoing detailed description, the present invention provides an improved system and method for clustering objects using indexes for a matrix representing a collection of objects. Any collection of objects may be grouped into clusters of objects. Notably, the objects may be clusters themselves that may be correlated into a hierarchy of clusters. To produce higher levels of the hierarchy, additional rounds of merging may be performed after joining the clusters into metanodes and/or defining a similarity function suitable for clusters. Such a system and method may support many applications that may cluster a collection of objects. As a result, the system and method provide significant advantages and benefits needed in contemporary computing.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for clustering objects, comprising:
a clustering analysis engine for grouping objects into clusters; and
an index generator operably coupled to the clustering analysis engine for creating an indexes on rows and columns of a matrix representing the objects.

2. The system of claim 1 further comprising a correlation analyzer operably coupled to the clustering analysis engine for determining a correlation between objects.

3. The system of claim 1 further comprising a cluster generator operably coupled to the clustering analysis engine for generating clusters by joining correlated objects in a same cluster.

4. A computer-readable medium having computer-executable components comprising the system of claim 1.

5. A computer-implemented method for clustering objects, comprising:
receiving a rectangular matrix with one or more rows representing an object from a collection of objects;
creating indexes for rows and columns of the rectangular matrix;
joining nearest nodes represented by the one or more rows to produce disjoint sets of nodes representing clusters of objects; and
outputting the disjoint sets of nodes representing the clusters of objects.

6. The method of claim 5 wherein joining nearest nodes represented by the one or more rows to produce disjoint sets of nodes representing clusters of objects comprises using a forward index on the nodes represented by rows of the matrix to find a subset of the nodes represented by columns that may be connected from the nodes represented by rows.

7. The method of claim 6 further comprising using a backward index on the found subset of nodes represented by columns of the matrix to find a subset of nodes represented by rows that may be connected from the found subset of nodes.

8. The method of claim 7 further comprising determining correlated nodes from the nodes represented by rows connecting to the found subset of nodes represented by the columns and from the subset of nodes represented by rows connected from the found subset of nodes represented by columns.

9. The method of claim 8 further comprising joining correlated nodes to produce disjoint sets representing clusters of objects.

10. The method of claim 8 wherein determining correlated nodes from the nodes represented by rows connecting to the found subset of nodes represented by the columns and from the subset of nodes represented by rows connected from the found subset of nodes represented by columns further comprises performing a depth first search of the nodes represented by rows connecting to the found subset of nodes represented by the columns.

11. The method of claim 9 wherein joining correlated nodes to produce disjoint sets representing clusters of objects comprises using a union-find algorithm to join correlated nodes.

12. A computer-readable medium having computer-executable instructions for performing the method of claim 5.

13. A computer system for clustering objects, comprising:
means for receiving a rectangular matrix with one or more rows representing an object from a collection of objects;
means for creating indexes for rows and columns of the rectangular matrix;
means for joining nearest nodes represented by the one or more rows to produce disjoint sets representing clusters of a level of a hierarchical clustering; and
means for outputting the disjoint sets of each level of the hierarchical clustering.

14. The computer system of claim 13 further comprising means for producing additional disjoint sets representing additional clusters of another level of the hierarchical clustering.

15. The computer system of claim 13 further comprising means for producing disjoint sets representing clusters of a level of a hierarchical clustering.

16. The method of claim 13 wherein means for joining nearest nodes represented by the one or more rows to produce disjoint sets representing clusters of a level of a hierarchical clustering comprises means for finding a subset of the nodes represented by columns that may be connected from the clusters represented by rows.

17. The method of claim 16 further comprising means for finding a subset of clusters represented by rows that may be connected from the found subset of nodes represented by columns.

18. The method of claim 17 further comprising means for determining correlated clusters from the clusters represented by rows connecting to the found subset of nodes represented by the columns and from the subset of clusters represented by rows connected from the found subset of nodes represented by columns.

19. The method of claim 18 further comprising means for joining correlated clusters to produce disjoint sets representing clusters of a level of a hierarchical clustering.

20. The method of claim 13 further comprising means for determining whether to produce additional disjoint sets representing additional clusters of another level of the hierarchical clustering.
